(19) United States
(12) Patent Application Publication
(10) Pub. No.: US 2016/0363460 A1
(43) Pub. Date: Dec. 15, 2016

(54) ORIENTATION MODEL FOR INERTIAL DEVICES

(71) Applicant: 7725965 CANADA INC., Saint-Bruno-de-Montarville (CA)

(72) Inventor: Omid SARBISHEI, Montreal (CA)

(21) Appl. No.: 15/179,182

(22) Filed: Jun. 10, 2016

Related U.S. Application Data
(60) Provisional application No. 62/174,765, filed on Jun. 12, 2015.

(51) Int. Cl. G01C 25/00

(52) U.S. Cl. CPC G01C 25/005

(57) ABSTRACT

There is described a computationally efficient quaternion-based orientation estimation model for a moving object using a specialized gradient descent correction step.

### CROSS-REFERENCE TO RELATED APPLICATIONS

The present application claims priority under 35 U.S.C. 119(e) of U.S. Provisional Patent Application No. 62/174,765 filed on Jun. 12, 2015, the contents of which are hereby incorporated by reference.

### TECHNICAL FIELD

The present disclosure relates to methods and systems for determining the orientation of a moving object in three-dimensional space, such as those found in inertial navigation systems, inertial measurement units, and magnetic angular rate and gravity sensor arrays.

### BACKGROUND OF THE ART

Orientation estimation of a moving object in three-dimensional space is a challenging problem, which has vast applications in gaming, avionics, wearable devices, etc. The orientation estimation can be performed either online using a microcontroller on the device, or offline using a separate computer, depending on the application. While offline approaches can support complex calculations, online approaches have different requirements, such as real-time calculations and low power consumption. Utilizing low-cost and low-power microcontrollers for real-time applications is not compatible with orientation estimation techniques that involve intensive arithmetic computations.

Conventional orientation estimation methods are based on either using direct Euler angle representations or the quaternion representation. A quaternion is a four-dimensional complex number that can be used to represent the orientation of a rigid body or coordinate frame in three-dimensional space. The quaternion representation avoids trigonometric matrix calculations, and thus, is more efficient computationally compared to the Euler angle transformations. Furthermore, Euler angle representations suffer from singularity conditions, which is not the case with the quaternion model.

Some solutions exist which make use of the quaternion representation for orientation estimation, namely Kalman-based methods. Although accurate, these methods are not computationally-efficient for low-power embedded applications. In fact, Kalman filters involve matrix inversions, covariance matrix calculations, etc., which makes them inefficient to meet the low power and real-time performance constraints imposed by some applications.

Another solution, known as the Madgwick orientation filter, is a computationally-efficient method, which makes use of the quaternion representation and is suitable for low-power real-time applications. However, there is a need for improved overall accuracy of the filter, without increasing computational costs.

### SUMMARY

There is described a computationally efficient quaternion-based orientation estimation model for a moving object using a specialized gradient descent correction step.

In accordance with a first broad aspect, there is provided a computer-implemented method for estimating an orientation of a moving object in three-dimensional space. The method comprises obtaining filtered and calibrated angular velocity readings of the object; computing a first correction vector by directing a quaternion orientation estimate at time t−1 towards the angular velocity readings found at time t to generate a quaternion orientation estimate of the angular velocity readings at time t; obtaining filtered and calibrated proper acceleration readings of the object; computing a second correction vector by directing the quaternion orientation estimate of the angular velocity readings at time t towards the proper acceleration readings found at time t; and using the second correction vector as a measurement error for estimating the orientation of the moving object at time t.

In some embodiments, the method further comprises obtaining filtered and calibrated heading angle readings of the object, and wherein computing the second correction vector comprises directing the quaternion orientation estimate of the angular velocity readings at time t towards the proper acceleration readings and the heading angle readings found at time t.

In some embodiments, the method further comprises detecting a temporary disturbance in the proper acceleration readings at time t, and adjusting the second correction vector at time t to account for the temporary disturbance. In some embodiments, adjusting the second correction vector at time t comprises applying at least one confidence weight to the proper acceleration readings, and adjusting the confidence weight at time t when the temporary disturbance is detected.

In some embodiments, the method further comprises detecting a temporary disturbance in at least one of the proper acceleration readings and the heading angle readings at time t, and adjusting the second correction vector at time t to account for the temporary disturbance.

In some embodiments, the method further comprises determining a zero-bias drift in the angular velocity readings for stationary positions of the object by computing a mean value of the angular velocity readings, and correcting for the zero-bias drift.

In some embodiments, the method further comprises determining a zero-bias drift in the angular velocity readings for stationary or non-stationary positions of the object using the quaternion orientation estimate at time t−1, and correcting for the zero-bias drift.

In some embodiments, the first correction vector and the second correction vector are both quaternions, computing the first correction vector comprises numerically integrating a quaternion derivative which is found using the proper angular velocity readings, and computing the second quaternion comprises computing a gradient descent.

In some embodiments, the method is implemented by an inertial measurement unit (IMU) sensor array. In some embodiments, the method is implemented by a Magnetic Angular Rate and Gravity (MARG) sensor array.

In accordance with another broad aspect, there is provided a system for estimating an orientation of a moving object in three-dimensional space. The system comprises a processing unit and a non-transitory memory communicatively coupled to the processing unit and comprising computer-readable program instructions. The instructions are executable by the processor for obtaining filtered and calibrated angular velocity readings of the object; computing a first correction vector by directing a quaternion orientation estimate at time t−1 towards the angular velocity readings found at time t to generate a quaternion orientation estimate of the angular velocity readings at time t; obtaining filtered and calibrated proper acceleration readings of the object; computing a second correction vector by directing the quaternion orientation estimate of the angular velocity readings at time t towards the proper acceleration readings found at time t; and using the second correction vector as a measurement error for estimating the orientation of the moving object at time t.

In some embodiments, the memory and processing unit are provided on a single integrated circuit as part of a microcontroller. In some embodiments, the system is embedded on the object.

In some embodiments, the program instructions are further executable by the processing unit for obtaining filtered and calibrated heading angle readings of the object, and wherein computing the second correction vector comprises directing the quaternion orientation estimate of the angular velocity readings at time t towards the proper acceleration readings and the heading angle readings found at time t.

In some embodiments, the program instructions are further executable by the processing unit for detecting a temporary disturbance in the proper acceleration readings at time t, and adjusting the second correction vector at time t to account for the temporary disturbance.

In some embodiments, adjusting the second correction vector at time t comprises applying at least one confidence weight to the proper acceleration readings, and adjusting the confidence weight at time t when the temporary disturbance is detected.

In some embodiments, the program instructions are further executable by the processing unit for detecting a temporary disturbance in at least one of the proper acceleration readings and the heading angle readings at time t, and adjusting the second correction vector at time t to account for the temporary disturbance.

In some embodiments, the program instructions are further executable by the processing unit for determining a zero-bias drift in the angular velocity readings for stationary positions of the object by computing a mean value of the angular velocity readings, and correcting for the zero-bias drift.

In some embodiments, the program instructions are further executable by the processing unit for determining a zero-bias drift in the angular velocity readings for stationary or non-stationary positions of the object using the quaternion orientation estimate at time t−1, and correcting for the zero-bias drift.

In some embodiments, the first correction vector and the second correction vector are both quaternions, computing the first correction vector comprises numerically integrating a quaternion derivative which is found using the proper angular velocity readings, and computing the second quaternion comprises computing a gradient descent.

In some embodiments, obtaining the various readings for use in the method and/or by the system comprises measuring such data using appropriate measurement devices, such as gyroscopes, accelerometers, and/or magnetometers, and correcting (i.e. filtering and calibrating) such data accordingly. In some embodiments, obtaining the readings comprises receipt of such data from another source which has obtained the readings and corrected them if required. In some embodiments, the source from which the readings are received is local while in other embodiments, the source is remote.

The methods and systems described herein may be used for online and/or offline applications.

The following notations and definitions will be used throughout the present disclosure.

Definition 1: The Euler angles are denoted in the reference (Earth) frame with North, East and Up vectors as follows:

Yaw ψ rotation around z-axis (Up) in the reference frame.

Pitch θ: rotation around y-axis (East) in the reference frame.

Roll φ: rotation around x-axis (North) in the reference frame.

The Euler angles are defined in the so-called aerospace sequence, where rotation around the z-axis (Yaw) takes place first, which is then followed by Pitch and Roll, respectively. The analysis is also applicable to other rotation sequences and Earth frames as well.

Definition 2: The IMU/MARG sensor frame (ridged body) uses \hat{x}, ŷ, \hat{z} as the principal axes, which correspond to the sensor readings.

Definition 3: The unit-length quaternion q_{r,t}=[q_{r,t,1} q_{r,t,2} q_{r,t,3} q_{r,t,4}], where ∥q_{r,t}∥=\sqrt{q_{r,t,1}²+q_{r,t,2}²+q_{r,t,3}²+q_{r,t,4}²}=1, represents the actual (reference) orientation of the sensor frame relative to the earth frame at time t. The conjugate of q_{r,t} will swap the relative frames and is defined as:

q*_{r,t}=[q_{r,t,1}−q_{r,t,2}−q_{r,t,3}−q_{r,t,4}].

Definition 4: The quaternion estimation at time t is denoted as:

q_{est,t}=[q_{est,t,1}q_{est,t,2}q_{est,t,3}q_{est,t,4}],

which is found by the orientation filter. The error in orientation estimation at time t is represented as:

e_{q,t}=q_{est,t}−q_{r,t}=[e_{q,t,1}e_{q,t,2}e_{q,t,3}e_{q,t,4}].

That is to say:

e_{q,t,j}=q_{est,t,j}−Q_{r,t,j}, where jε{1,2,3,4}.

Definition 5: The Hamilton product of the two quaternions qₐ=[q_{a,1} q_{a,2} q_{a,3} q_{a,4}], q_{b}=[q_{b,1} q_{b,2} q_{b,3} q_{b,4}], results in another quaternion, which is given by:

$${q}_{a} ⊗ {q}_{b} = {[ \begin{matrix}{q}_{a , 1} {q}_{b , 1} - {q}_{a , 2} {q}_{b , 2} - {q}_{a , 3} {q}_{b , 3} - {q}_{a , 4} {q}_{b , 4} \\ {q}_{a , 1} {q}_{b , 2} + {q}_{a , 2} {q}_{b , 1} + {q}_{a , 3} {q}_{b , 4} - {q}_{a , 4} {q}_{b , 3} \\ {q}_{a , 1} {q}_{b , 3} - {q}_{a , 2} {q}_{b , 4} + {q}_{a , 3} {q}_{b , 1} + {q}_{a , 4} {q}_{b , 2} \\ {q}_{a , 1} {q}_{b , 4} + {q}_{a , 2} {q}_{b , 3} - {q}_{a , 3} {q}_{b , 2} + {q}_{a , 4} {q}_{b , 1}\end{matrix} ]}^{T} .$$

It is notable that qₐ [symbol] q_{b}≠q_{b} [symbol] qₐ.

Definition 6: The current calibrated accelerometer, magnetometer, and gyroscope readings in the sensor frame at time t are denoted as S_{a,t}=(a_{\hat{x}}, a_{ŷ}, a_{\hat{z}}), S_{m,t}=(m_{\hat{x}}, m_{ŷ}, m_{\hat{z}}), and S_{g,t}=(g_{\hat{x}}, g_{ŷ}, g_{\hat{z}}), respectively. The current accelerometer/magnetometer (Acc/Mag) readings at time t are together represented as S_{am,t}={S_{a,t}, S_{m,t}}. Note that regarding the IMU filter, since there is no magnetometer, S_{am,t}=S_{a,t}.

The sensors are considered to have passed the initial necessary low-pass filters and to be time synchronized. The calibrated accelerometer/magnetometer data S_{a,t}, S_{m,t} are also considered to have passed a normalization step to represent unit-length readings, i.e., ∥S_{a,t}∥=∥S_{m,t}∥=1. We also denote the norm of Acc/Mag readings pre-normalization as ∥Ŝ_{a,t}∥ and ∥Ŝ_{m,t}∥. These norm values are used in detecting temporary disturbances in calibrated Acc/Mag readings, while the normalized calibrated readings S_{a,t}, S_{m,t} are used in the normal filter operation mode.

Definition 7: The error in current calibrated accelerometer, magnetometer and gyroscope readings S_{a,t}, S_{m,t}, S_{g,t} are denoted as (êₐₓ, ê_{ay}, ê_{az}), (êₘₓ, ê_{my}, ê_{mz}) and (ê_{gx}, ê_{gy}, ê_{gz}), respectively.

### BRIEF DESCRIPTION OF THE DRAWINGS

Further features and advantages of the present invention will become apparent from the following detailed description, taken in combination with the appended drawings, in which:

FIG. 1 is a flowchart of an exemplary method for estimating an orientation of a moving object in three-dimensional space;

FIG. 2 is a block diagram of an exemplary orientation model for obtaining a correction vector q′_{∇,t};

FIG. 3 is a block diagram of an exemplary implementation of the orientation model of FIG. 2 for an IMU filter;

FIG. 4 is a block diagram of an exemplary implementation of the orientation model of FIG. 2 for a MARG filter;

FIG. 5 is an exemplary graph of the reference pitch angles showing variable angular velocities;

FIG. 6 is an exemplary graph tracking the offset drift in pitch using two filters featuring a 45 second step-response time; and

FIG. 7 is an exemplary system for implementing the method of FIG. 1.

It will be noted that throughout the appended drawings, like features are identified by like reference numerals.

### DETAILED DESCRIPTION

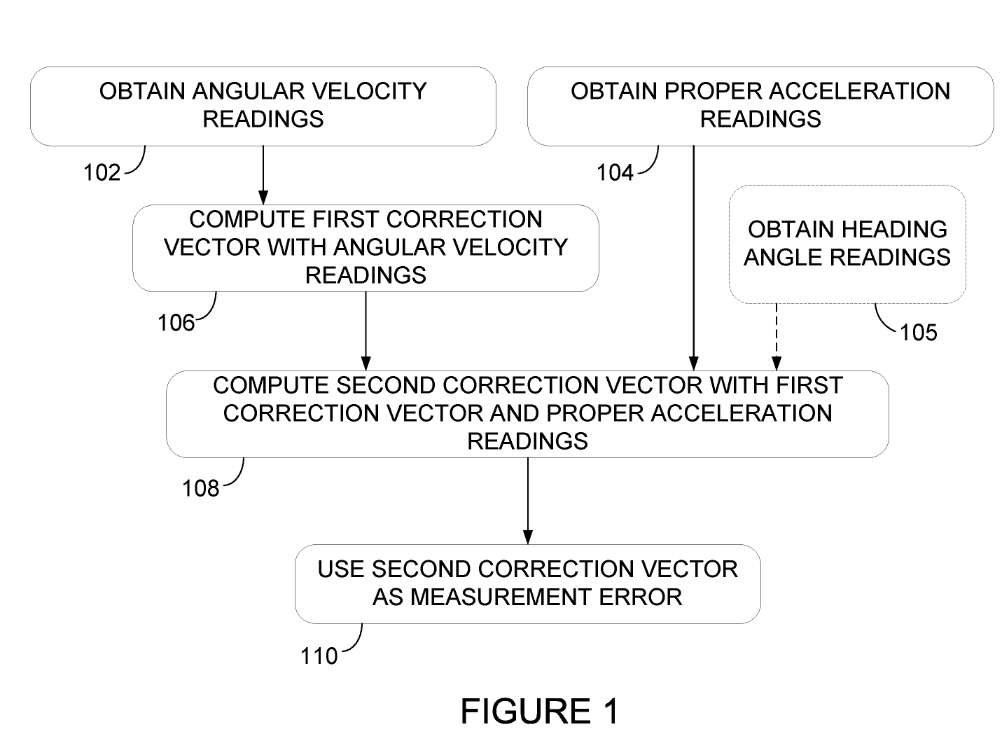

FIG. 1 is an exemplary flowchart of a computer-implemented method for estimating an orientation of a moving object in three-dimensional space. At least two types of readings are obtained from the moving object, namely angular velocity readings and proper acceleration readings, as per 102, 104. The proper acceleration may be obtained using a device such as an accelerometer. The angular velocity may be obtained using a device such as a gyroscope. Any other measuring device capable of obtaining this data may also be used. In some embodiments, a third type of readings are also obtained. They are heading angle readings of the object, as illustrated in optional step 105, and they may be used for certain applications or simply to provide a gain in performance, as will be explained in more detail below. The heading angle may be obtained using a device such as a magnetometer.

As per 106, the angular velocity readings are used to compute a first correction vector. The first correction vector takes the form of a quaternion orientation estimate based on the angular velocity readings of the object at time t. It is obtained by directing a quaternion orientation estimate at time t−1 towards the angular velocity readings found at time t. The first correction vector is then used in conjunction with the proper acceleration readings to compute a second correction vector, as per 108. The second correction vector is a result of directing the quaternion orientation estimate of the angular velocity readings at time t towards the proper acceleration readings found at time t. If the acceleration readings are improper due to the presence of a temporary high external force, the second correction vector may be adjusted with a confidence weight. As per 110, the second correction vector may then be used as a measurement error for estimating the orientation of the moving object at time t.

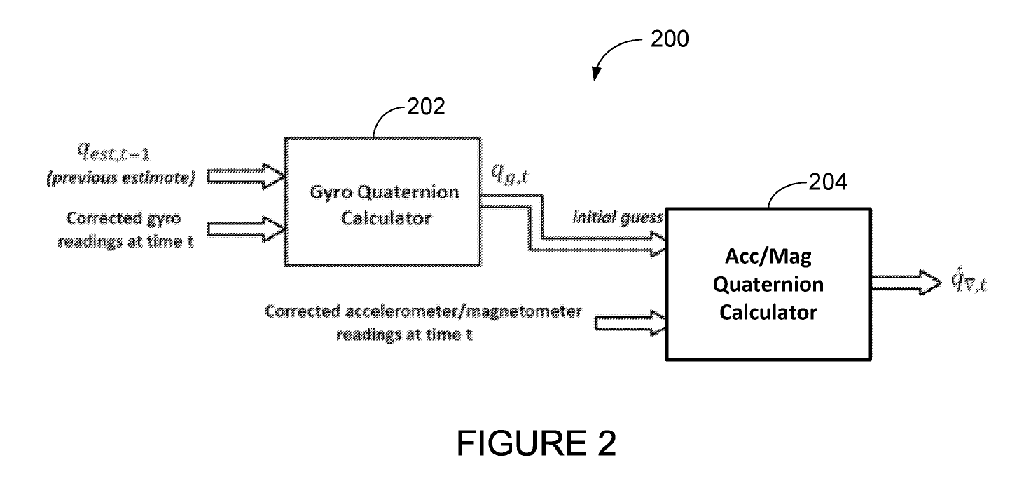

FIG. 2 is an exemplary illustration of an orientation model 200 for obtaining the second correction vector, labeled as q′_{∇,t}. A gyro quaternion calculator 202 receives as input an initial guess at time t=0, which becomes a previous estimate q_{est,t-1} after a first iteration of the process. Corrected angular velocity readings are also received. These readings are said to be corrected in that they have been filtered, calibrated, and normalized where necessary for further processing. The gyro quaternion calculator 202 computes the first correction vector, labeled as q_{g,t}, which is a quaternion orientation estimate of the angular velocity at time t. The output of the gyro quaternion calculator 202 may then be used as one of the inputs to an Acc/Mag quaternion calculator 204, as its initial guess/q_{est,t-1} input. The other input of the Acc/Mag quaternion calculator 204 is the corrected proper acceleration readings and in some embodiments, heading angle readings. The Acc/Mag quaternion calculator 204 computes q′_{∇,t}, which is the second correction vector. The Acc/Mag quaternion calculator 204 is responsible for rejecting the effect of temporary disturbance in calibrated Acc/Mag readings as well.

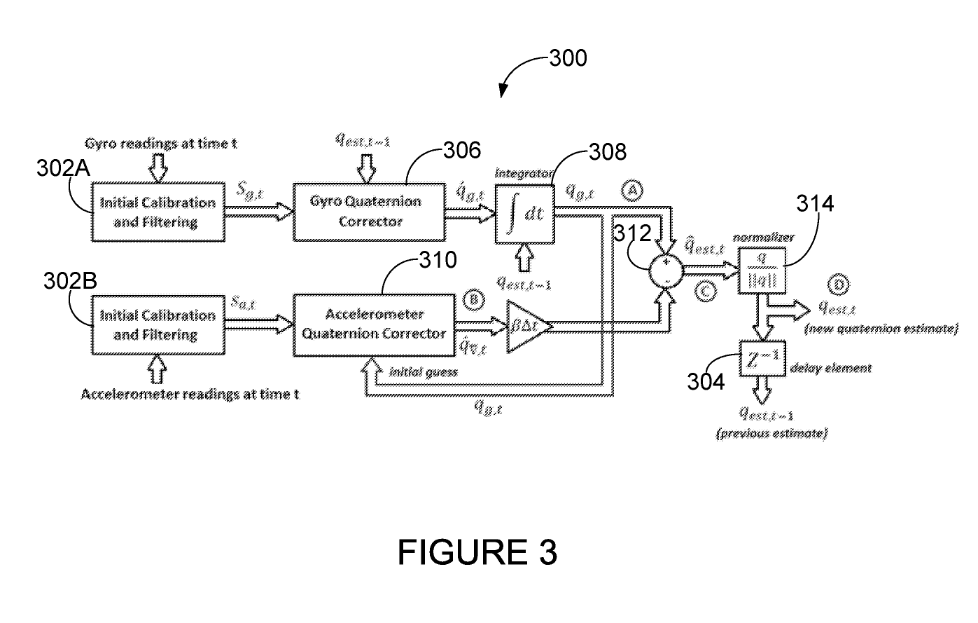

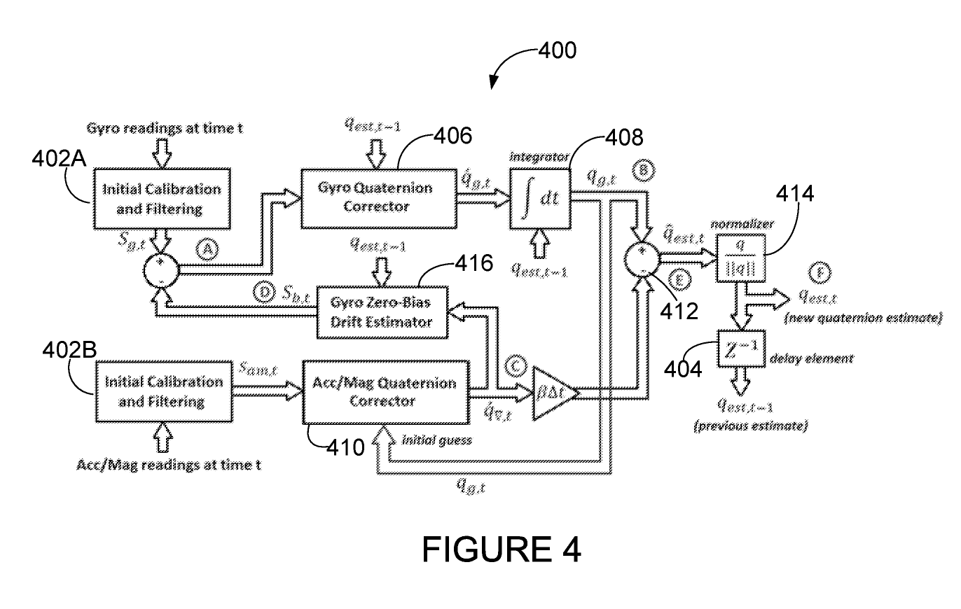

In some embodiments, the orientation model 200 of FIG. 2 is applied as an orientation filter for Inertial Measurement Unit (IMU) sensor arrays. One such example is illustrated in FIG. 3. In some embodiments, the orientation model 200 of FIG. 2 is applied as an orientation filter for Magnetic Angular Rate and Gravity (MARG) sensor arrays. One such example is illustrated in FIG. 4. These two embodiments will be described concurrently with regards to certain aspects of the functionality of the orientation filters 300, 400.

The IMU and MARG sensor readings are assumed to have initially passed the necessary calibration, filtering, and normalization techniques, which are represented by the initial calibration and filtering modules 302a, 302b, 402a, 402b. For instance, low-pass or high-pass filters might be used to remove the undesirable frequencies from sensor readings depending on the application. Calibration techniques may aim to remove the potential offset and gain from sensor readings. Generally, for a 3-axis raw sensor reading X_{3×1}, the following calibration may be performed:

X_{calib}=G_{3×3}X+C_{3×1}, (1)

where G_{3×3} is the gain matrix and C_{3×1} is the offset. For instance, regarding accelerometers, the values of G_{3×3} and C_{3×1} can be found using six stationary positions and a linear least-squares fit solution. Furthermore, regarding magnetometers, a least-squares ellipsoid fit may be used to find G_{3×3} and C_{3×1} and remove the magnetic distortion, including hard iron and soft iron effects along with sensor axes misalignments. Note that regarding accelerometer and magnetometer readings, a normalization step may take place post-calibration to represent unit-length vectors.

The delay elements (Z⁻¹) 304, 404 may be registers that capture the previous estimate a Q_{est,t-1} and use it as a feedback input to the systems 300, 400. Note that initially at time t=t₀, we can reset the quaternion estimate q_{est,t}_{₀} to q_{est,t}_{₀}=[1 0 0 0], which indicates that all Euler angles are initially zero.

The gyro quaternion correctors 306, 406 directly predict the quaternion derivative \acute{q}_{g,t} using the information from gyros S_{g,t} as well as the previous estimate a Q_{est,t-1} as follows:

\acute{q}_{g,t}=½q_{est,t-1} [symbol] [0g_{\hat{x}}g_{ŷ}g_{\hat{z}}]. (2)

After obtaining \acute{q}_{g,t} in Eq. (2), we can find an initial estimate for quaternion orientation at time t using the integrators 308, 408 as follows:

q_{g,t}=q_{est,t-1}+\acute{q}_{g,t}Δt, (3)

where Δt is the sampling period and \acute{q}_{g,t} is given by Eq. (2).

The Acc/Mag quaternion correctors 310, 410 predict a correction vector that pushes the initial guess qᵢₙᵢₜ, where qᵢₙᵢₜ=q_{q,t}, towards a unit-length quaternion q that ideally matches the Acc/Mag readings S_{am,t}. In the case of the IMU filter 300, the block 310 is called the accelerometer quaternion corrector, since magnetometers are not used. Quaternion correctors 310, 410 will generate the following output:

\acute{q}_{∇,t}≈αₜ(qᵢₙᵢₜ−q)=αₜ(Q_{g,t}−q), (4)

where αₜ>0 is an arbitrary gain depending on how fast the estimator is pushing its initial guess qᵢₙᵢₜ towards q. If αₜ=1, then by removing the correction vector \acute{q}_{∇,t} from the initial guess qᵢₙᵢₜ, we would reach the reference quaternion q:

q≈qᵢₙᵢₜ−\acute{q}_{∇,t}=q_{g,t}−q_{∇,t}. 5)

If the initial guess qᵢₙᵢₜ is close to q, the estimate \acute{q}_{∇,t} can be found with good precision using optimization methods, such as Newton-Raphson and Quasi-Newton solutions. However, such methods come with a high computational cost, which is not desirable in low-power embedded applications. A computationally-efficient single-step gradient descent solution may be used to find the correction vector \acute{q}_{∇,t}. Note that one can use more iterations within the gradient descent step, if needed. The proposed gradient descent solution makes use of the initial guess qᵢₙᵢₜ=q_{q,t}, which is given by Eq. (3).

The gradient descent step delivers the following correction quaternion:

\acute{q}_{∇,t}=∇F(q_{g,t},S_{am,t}), (6)

where ∇F is the gradient of the function F, which is given below:

F(q_{g,t},S_{am,t})=½F_{g}(q_{g,t},S_{am,t})^{T}F_{g}(q_{g,t},S_{am,t}). (7)

The function F_{g}(g_{g,t}, S_{am,t}) is arbitrarily chosen to represent the mismatch between the Acc/Mag readings S_{am,t} and the initial guess q_{g,t}=[q₁, q₂, q₃, q₄]. For the IMU filter 300, we can use the following mismatch function:

$${F}_{g} ( {q}_{g , t} , {S}_{a , t} ) = {q}_{g , t}^{*} ⊗ g ⊗ {q}_{g , t} - {S}_{a , t} {⇒}^{g = [ \begin{matrix}0 & 0 & 0 & 1\end{matrix} ]} = {[ \begin{matrix}2 ( {q}_{2} {q}_{4} - {q}_{1} {q}_{3} ) - {a}_{\hat{x}} \\ 2 ( {q}_{1} {q}_{2} - {q}_{3} {q}_{4} ) - {a}_{\hat{y}} \\ 1 - 2 ( {q}_{2}^{2} + {q}_{3}^{2} ) - {a}_{\hat{z}}\end{matrix} ]}_{3 \times 1} , \qquad ( 8 )$$

where g=[0 0 0 1] is a quaternion representing the reference gravity vector in the Earth frame.

The gradient in Eq. (6) is then computed as follows:

\acute{q}_{∇,t}=∇F(q_{g,t},S_{am,t})=J_{F}_{_{g}}(q_{g,t})^{T}F_{g}(q_{g,t},S_{am,t}), (9)

where J_{F}_{_{g}}(q_{g,t}) is the Jacobian of F_{g} at q=q_{g,t}. Considering F_{g} in Eq. (8), we get:

$${J}_{{F}_{g}} ( {q}_{g , t} ) = [ \begin{matrix}\frac{\partial {F}_{g , 1}}{\partial {q}_{1}} & \frac{\partial {F}_{g , 1}}{\partial {q}_{2}} & \frac{\partial {F}_{g , 1}}{\partial {q}_{3}} & \frac{\partial {F}_{g , 1}}{\partial {q}_{4}} \\ \frac{\partial {F}_{g , 2}}{\partial {q}_{1}} & \frac{\partial {F}_{g , 2}}{\partial {q}_{2}} & \frac{\partial {F}_{g , 2}}{\partial {q}_{3}} & \frac{\partial {F}_{g , 2}}{\partial {q}_{4}} \\ \frac{\partial {F}_{g , 3}}{\partial {q}_{1}} & \frac{\partial {F}_{g , 3}}{\partial {q}_{2}} & \frac{\partial {F}_{g , 3}}{\partial {q}_{3}} & \frac{\partial {F}_{g , 3}}{\partial {q}_{4}}\end{matrix} ] = {[ \begin{matrix}- 2 {q}_{3} & 2 {q}_{4} & - 2 {q}_{1} & 2 {q}_{2} \\ 2 {q}_{2} & 2 {q}_{1} & 2 {q}_{4} & 2 {q}_{3} \\ 0 & - 4 {q}_{2} & - 4 {q}_{3} & 0\end{matrix} ]}_{3 \times 4} , \qquad ( 10 )$$

where F_{g,j} (j=1, 2, 3), is the j^{th} row of F_{g}.

The final adders 312, 412 remove the correction vector \acute{q}_{∇,t} multiplied by a gain, i.e., βΔt, where Δt is the sampling period, from the gyros' estimate found at time t, i.e., q_{g,t} in Eq. (3):

\hat{q}_{est,t}=q_{g,t}−(βΔt)\acute{q}_{∇,t}, (11)

The tunable gain β can be set adaptively based on sensor characteristics and the presence of disturbance in sensor readings to achieve optimal accuracy. We might also set a default optimal value for β, where initially a higher gain is chosen to provide convergence.

The normalizers 314, 414 normalize the estimate \hat{q}_{est,t} in Eq. (11) to deliver the new unit-length quaternion estimate

$${q}_{est , t} = \frac{{\hat{q}}_{est , t}}{‖ {\hat{q}}_{est , t} ‖} .$$

The zero-bias drift effect of gyroscopes can be compensated by detecting stationary positions and finding the mean value of the gyro readings. However, such methods are not capable of removing the bias drift, as the device is moving. For that purpose, a gyro zero-bias drift estimator 416 may be used for the MARG filter 400 to predict the zero-bias drift in gyroscope readings over time S_{b,t}.

The zero-bias value for gyros can be represented by the DC component of the gyros' quaternion error at time t, i.e., (2q*_{est,t-1} [symbol] \acute{q}_{∇,t}), and it can be found using the following integrator:

S_{b,t}=ξΣₜ(2q*_{est,t-1} [symbol] \acute{q}_{∇,t})Δt, (12)

where ξ is another filter gain representing the response time in tracking the zero-bias drift. Since the zero-bias drift phenomena takes effect slowly over time, we can set ξ to a small value. The bias values S_{b,t} are initially subtracted from the gyro readings S_{g,t}, and later, the corrected readings S_{g,t}−S_{b,t} are fed through the gyro quaternion estimator 406. Note that we may initially set ξ=0, until gyros' estimate converges to the Acc/Mag readings, and then we switch to the optimal values of β and ξ.

The Acc/Mag quaternion corrector 410 makes use of the information from the initial guess q_{g,t} (current gyro estimate) in its gradient descent initialization to compute the correction vector \acute{q}_{∇,t}. This results in an overall performance improvement of the filter in tracking the zero-bias drift in gyro readings, since \acute{q}_{∇,t} directly represents the mismatch between the current gyro estimate and the current Acc/Mag readings.

Presented below is one possible way to realize the calculations required for the proposed IMU filter structure 300 in FIG. 3. The following steps can be taken to realize the IMU filter 300 starting from the initial quaternion q_{est,0}=[1 0 0 0] at t=0.

Step 1 (Finds (A) in FIG. 3): Calculate the gyro estimate q_{g,t}=[q₁, q₂, q₃, q₄] using Eq. (2) and Eq. (3):

$${q}_{g , t} = {q}_{est , t - 1} + {{q}^{′}}_{g , t} Δ t = {q}_{est , t - 1} + \frac{Δ t}{2} {q}_{est , t - 1} ⊗ [ 0 {g}_{\hat{x}} {g}_{\hat{y}} {g}_{\hat{z}} ] . \qquad ( 13 )$$

Step 2: Build the mismatch function Fₐ(q_{g,t}, S_{a,t}) as follows:

$${F}_{a} ( {q}_{g , t} , {S}_{a , t} ) = {q}_{g , t}^{*} ⊗ g ⊗ {q}_{g , t} - {S}_{a , t} {}^{g = [ 0 \; 0 \; 0 \; 1 ]} = {[ \begin{matrix}2 ( {q}_{2} {q}_{4} - {q}_{1} {q}_{3} ) - {a}_{\hat{x}} \\ 2 ( {q}_{1} {q}_{2} + {q}_{3} {q}_{4} ) - {a}_{\hat{y}} \\ 1 - 2 ( {q}_{2}^{2} + {q}_{3}^{2} ) - {a}_{\hat{z}}\end{matrix} ]}_{3 \times 1} \qquad ( 14 )$$

Step 3: Find the Jacobian of Fₐ at q=q_{g,t}=[q₁, q₂, q₃, q₄]:

$${J}_{{F}_{a}} = {[ \begin{matrix}- 2 {q}_{3} & 2 {q}_{4} & - 2 {q}_{1} & 2 {q}_{2} \\ 2 {q}_{2} & 2 {q}_{1} & 2 {q}_{4} & 2 {q}_{3} \\ 0 & - 4 {q}_{2} & - 4 {q}_{3} & 0\end{matrix} ]}_{3 \times 4} \qquad ( 15 )$$

Step 4 (Finds (B) in FIG. 3): Use the mismatch function Fₐ(q_{g,t}, S_{a,t}) from Step 2 and its Jacobian in Step 3 to find the quaternion correction \acute{q}_{∇,t} as follows:

\acute{q}_{∇,t}=∇F(q_{g,t},S_{a,t})=J_{F}_{ₐ}^{T}Fₐ. (16)

Step 5 (Finds (C) in FIG. 3): Find the new estimate:

\hat{q}_{est,t}=q_{g,t}−βΔt(\acute{q}_{∇,t}), (17)

where β may be set based on the sensor error characteristics to achieve maximum accuracy. We can use multiple modes to set different values of β. Namely, one can choose a higher gain for β, i.e., β=β_{fast}, when a high mismatch is observed between the sensor readings, e.g., when ∥Fₐ∥ or maxⱼ(|F_{a,j}|) exceeds a certain threshold, where F_{a,j} is the j^{th} row of Fₐ. Using such an approach, the gyro readings are pushed faster towards accelerometer readings, when a high mismatch is observed between the sensor readings, e.g., in the beginning during convergence. As the estimates get closer to each other, i.e., ∥Fₐ∥ and maxⱼ(|F_{a,j}|) become low enough, we will switch back to the lower and optimal value of β to observe a smoother response.

When a major external force is observed by accelerometers, e.g., ∥Ŝ_{a,t}∥>>1 or ∥Ŝ_{a,t}∥<<1, we can also temporarily set a lower gain for β, even β=0 to completely reject the effect of the observed temporary external force.

Step 6 (Finds (D) in FIG. 3): Normalize \hat{q}_{est,t},

$$i . e . , = \frac{{\hat{q}}_{est , t}}{‖ {\hat{q}}_{est , t} ‖} ,$$

to deliver a unit length quaternion estimate q_{est,t}.

A sample realization of the proposed MARG filter 400 in FIG. 4 is provided below.

Step 1 (Finds (A) in FIG. 4): Remove the gyros' zero-bias drift S_{b,t} from gyro readings S_{g,t}, i.e.,

ĝ_{\hat{x}}=g_{\hat{x}}−S_{b,t,2},ĝ_{ŷ}=g_{ŷ}−S_{b,t,3},ĝ_{\hat{z}}=g_{\hat{z}}−S_{b,t,4}, (18)

where initially at t=0, the bias values S_{b,t} are all zero, i.e.,

S_{b,0,2}=S_{b,0,3}=S_{b,0,4}=0. (19)

Furthermore, at t=0, we have: q_{est,0}=[1 0 0 0].

Step 2 (Finds (B) in FIG. 4): Use (ĝ_{\hat{x}}, ĝ_{ŷ}, ĝ_{\hat{z}}) from Step 1 to find the gyros' quaternion estimate at time t, i.e., q_{g,t}=[q₁ q₂ q₃ q₄], as follows:

$${q}_{g , t} = {q}_{est , t - 1} + \frac{Δ t}{2} {q}_{est , t - 1} ⊗ [ 0 {\hat{g}}_{\hat{x}} {\hat{g}}_{\hat{y}} {\hat{g}}_{\hat{z}} ] . \qquad ( 20 )$$

Step 3: Build an appropriate mismatch function \hat{F}(q_{g,t}, S_{am,t}) between the initial gyro estimate q_{g,t} from Step 2, and the Acc/Mag readings S_{am,t}.

$$\hat{F} ( {q}_{init} , {S}_{am , t} ) = {[ \begin{matrix}{k}_{a , t} {F}_{a} \\ {k}_{m , t} {F}_{m}\end{matrix} ]}_{6 \times 1} , \qquad ( 21 )$$

where Fₐ (Fₘ) is the mismatch between q_{g,t} and the accelerometer (magnetometer) readings S_{a,t} (S_{m,t}), while k_{a,t}, k_{m,t} are confidence weights. We choose to set qᵢₙᵢₜ=q_{g,t} in Eq. (21). Consequently, the function Fₐ in Eq. (21) is found by Eq. (14), and Fₘ, which is the mismatch between q_{g,t} and the magnetometer readings S_{m,t}, can be defined as follows:

$${F}_{m} ( {q}_{g , t} , {S}_{m , t} ) = {q}_{g , t}^{*} ⊗ E ⊗ {q}_{g , t} - {S}_{m , t} {}^{E = [ 0 {b}_{x} 0 {b}_{z} ]} = {[ \begin{matrix}2 {b}_{x} ( 0.5 - {q}_{3}^{2} - {q}_{4}^{2} ) + 2 {b}_{z} ( {q}_{2} {q}_{4} - {q}_{1} {q}_{3} ) - {m}_{\hat{x}} \\ 2 {b}_{x} ( {q}_{2} {q}_{3} - {q}_{1} {q}_{4} ) + 2 {b}_{z} ( {q}_{1} {q}_{2} + {q}_{3} {q}_{4} ) - {m}_{\hat{y}} \\ 2 {b}_{x} ( {q}_{1} {q}_{3} + {q}_{2} {q}_{4} ) + 2 {b}_{z} ( 0.5 - {q}_{2}^{2} - {q}_{3}^{2} ) - {m}_{\hat{z}}\end{matrix} ]}_{3 \times 1} , \qquad ( 22 )$$

where q_{g,t}=[q₁ q₂ q₃ q₄], and E=[0 bₓ 0 b_{z}] is the earth's magnetic field in the reference Earth frame defined by Definition 1. We also have:

bₓ=cos(δ), and b_{z}=−sin(δ), (23)

where −90°≦δ≦90° is the fixed dip angle depending on the geographic location on earth. The values of bₓ, b_{z} can be found using several methods, e.g., directly from the geographic location information, or by de-rotation of magnetometer readings back to the horizontal plane. Alternatively, we can find these values using the inner product of accelerometer and magnetometer readings. To do this more efficiently, a one-time solution would be to initially put the device in a stationary position for ˜1-2 seconds and find the mean values of the calibrated and normalized accelerometer and magnetometer readings S_{a,t} and S_{m,t} as Sₐ_{_}ₘₑₐₙ and Sₘ_{_}ₘₑₐₙ.

Next, we find the dip angle information by calculating the inner product of the mean values of the Acc/Mag readings:

b_{z}=−sin(δ)− [symbol] Sₐ_{_}ₘₑₐₙ,Sₘ_{_}ₘₑₐₙ [symbol] ;bₓ=\sqrt{1−b_{z}²}.

The above values of bₓ, b_{z} are initially stored in memory and will then be used as constant parameters for the orientation filter 400.

The function Fₘ in Eq. (22), which represents the mismatch between the gyro estimate q_{g,t} and magnetometer readings, might be defined in a different way depending on the type of information we receive from the corrected magnetometers. For example, one might utilize an intensive calibration and tilt-compensation algorithm for magnetometers, and directly find the yaw angle components cos(ψ), sin(ψ), in the xy horizontal plane. These yaw angle components might also be provided by another external source, e.g., a camera. Under such conditions, the mismatch function Fₘ in Eq. (22) can be simplified to:

$${F}_{m} ( {q}_{g , t} , {S}_{m , t} ) = {[ \begin{matrix}2 ( 0.5 - {q}_{3}^{2} - {q}_{4}^{2} ) - cos ( ψ ) \\ 2 ( {q}_{2} {q}_{3} - {q}_{1} {q}_{4} ) - sin ( ψ ) \\ 0\end{matrix} ]}_{3 \times 1} , \qquad ( 24 )$$

where q_{g,t}=[q₁ q₂ q₃ q₄], and the last row of Fₘ refers to the z-axis component in the xy horizontal plane, which is zero.

The confidence weights k_{a,t}, k_{m,t} will determine the amount of confidence we put in accelerometer and magnetometer readings at time t, respectively. This is particularly helpful in rejecting a temporary disturbance in Acc/Mag readings after initial calibration.

For simplicity, we can choose Boolean values for k_{a,t}, k_{m,t} as follows. Whenever a major disturbance or external force is observed by magnetometer (accelerometer) readings at some time t=t₁, we can temporarily set k_{m,t}=0 (k_{a,t}=0), at t=t₁. When the magnetometer (accelerometer) disturbance is gone, we switch back to the default value of k_{m,t}=1 (k_{a,t}=1).

Disturbance can simply be detected when the magnitude of the calibrated accelerometer or magnetometer readings pre-normalization, i.e., ∥Ŝ_{a,t}∥ or ∥Ŝ_{m,t}∥, exceeds its pre-defined disturbance-free upper/lower bound. The reason for this is that the gravity vector and the Earth's magnetic field have constant magnitude values for a certain geographic location, i.e., ∥Ŝ_{a,t}∥≈1 g, and ∥Ŝ_{m,t}∥≈B₀, where B₀ is the expected magnetic field intensity post-calibration. The disturbance-free upper/lower bounds for accelerometers and magnetometers are defined based on the initial calibration procedure.

In order to detect temporary disturbance on magnetometer data more accurately, we should additionally check the inner product of accelerometer and magnetometer vectors [symbol] S_{a,t}, S_{m,t} [symbol] , and if the result exceeds its pre-defined disturbance-free upper/lower bound, we can set k_{m,t}=0. The reason for this condition is that the dip angle δ between the disturbance-free calibrated and normalized accelerometer and magnetometer vectors is fixed for a specific geographic location, i.e., [symbol] S_{a,t}, S_{m,t} [symbol] ≈sin(δ). If the magnetic field is disturbance-free, i.e., ∥Ŝ_{m,t}∥≈B₀ and [symbol] S_{a,t}, S_{m,t} [symbol] ≈−sin(δ), then we set the default value of k_{m,t}=1 for normal filter operation.

In summary, the confidence weights k_{a,t}, k_{m,t} in Eq. (21) can be set using the following conditions:

$${k}_{a , t} = \{ \begin{matrix}1 & if ‖ {\hat{S}}_{a , t} ‖ \approx 1 g \\ 0 & otherwise\end{matrix} ; \\ {k}_{m , t} = \{ \begin{matrix}1 & if ( ‖ {\hat{S}}_{m , t} ‖ \approx {B}_{0} ) and ( 〈 {S}_{a , t} , {S}_{m , t} 〉 \approx {b}_{z} ) \\ 0 & otherwise\end{matrix} \qquad ( 25 )$$

Eq. (25) can be realized by comparing ∥Ŝ_{a,t}∥, ∥Ŝ_{m,t}∥, and [symbol] S_{a,t}, S_{m,t} [symbol] with their disturbance-free upper/lower bounds defined by the initial calibration procedure.

Note that more advanced and evolutionary observers can also be used to detect disturbance over time. However, using Eq. (25) one can detect temporary disturbance in accelerometer/magnetometer readings very effectively using only a few scalar arithmetic operations.

Step 4: Build the Jacobian of the mismatch function \hat{F}(q_{g,t}, S_{am,t}) from Step 3 at q=q_{g,t}, i.e., Ĵ(q_{g,t}). For instance, regarding \hat{F} in Eq. (21), we get:

$$\hat{J} ( {q}_{g , t} ) = {[ \begin{matrix}{k}_{a , t} {J}_{{F}_{a}} \\ {k}_{m , t} {J}_{{F}_{m}}\end{matrix} ]}_{6 \times 1} , \qquad ( 26 )$$

where J_{F}_{ₐ} is given by Eq. (15) and J_{F}_{ₘ} is found based on the definition of Fₘ. Regarding, the mismatch functions in Eq. (22) and Eq. (24), we have:

$${J}_{{F}_{m}} {}^{Eq . ( 22 )} = {[ \begin{matrix}- 2 {b}_{z} {q}_{3} & 2 {b}_{z} {q}_{4} & - 4 {b}_{x} {q}_{3} - 2 {b}_{z} {q}_{1} & - 4 {b}_{x} {q}_{4} + 2 {b}_{z} {q}_{2} \\ - 2 {b}_{x} {q}_{4} + 2 {b}_{z} {q}_{2} & 2 {b}_{x} {q}_{3} + 2 {b}_{z} {q}_{1} & 2 {b}_{x} {q}_{2} + 2 {b}_{z} {q}_{4} & - 2 {b}_{x} {q}_{1} + 2 {b}_{z} {q}_{3} \\ 2 {b}_{x} {q}_{3} & 2 {b}_{x} {q}_{4} - 4 {b}_{z} {q}_{2} & 2 {b}_{x} {q}_{1} - 4 {b}_{z} {q}_{3} & 2 {b}_{x} {q}_{2}\end{matrix} ]}_{3 \times 4} ; \\ {J}_{{F}_{m}} {}^{Eq . ( 24 )} = {[ \begin{matrix}2 {q}_{4} & 2 {q}_{3} & 2 {q}_{2} & 2 {q}_{1} \\ 0 & 0 & - 4 {q}_{3} & - 4 {q}_{4} \\ 0 & 0 & 0 & 0\end{matrix} ]}_{3 \times 4} \qquad ( 27 )$$

Step 5 (Finds (C) in FIG. 4): Use the mismatch function \hat{F}(q_{g,t}, S_{am,t}) from Step 3 and its Jacobian Ĵ(q_{g,t}) from Step 4 to find the quaternion correction \acute{q}_{∇,t} as follows:

\acute{q}_{∇,t}=∇F(g_{g,t},S_{am,t})=Ĵ^{T}(q_{g,t})\hat{F}(q_{g,t},S_{am,t}). (28)

Step 6 (Finds (D) in FIG. 4): Use \acute{q}_{∇,t} from Step 5 to update the gyros' zero-bias drift S_{b,t} based on Eq. (12):

S_{b,t+1}=S_{b,t}+ξΔt(2q*_{est,t-1} [symbol] \acute{q}_{∇,t}). (29)

Note that initially, when gyros are starting to converge to the Acc/Mag readings, we set ξ=0 in Eq. (29). Next, a desirable gain determining the response time is used to update the zero-bias drift values in real-time.

If Acc/Mag readings are temporarily observing disturbance or a major external force, we can skip the zero-bias drift update temporarily by setting S_{b,t+1}=S_{b,t}. Note that one might make use of another method to find the zero-bias drift values S_{b,t}. For instance, the zero-bias drift values S_{b,t} may be updated only within stationary positions.

Step 7 (Finds (E) in FIG. 4): Find the new estimate:

\hat{q}_{est,t}=q_{g,t}−βΔt(\acute{q}_{∇,t}), (30)

where once again, the filter gain β can be tuned to achieve optimal accuracy.

As explained above, we can also temporarily choose a higher gain for β, i.e., β=β_{fast}, when a high mismatch is observed between the sensor readings, e.g., when ∥F_{g}∥ or maxⱼ(|F_{g,j}|) exceeds a certain threshold.

Step 8 (Finds (F) in FIG. 4): Normalize the new estimate,

$$i . e . , {q}_{est , t} = \frac{{\hat{q}}_{est , t}}{‖ {\hat{q}}_{est , t} ‖} .$$

Note that one might execute Step 6 after Step 7 or Step 8 as well, i.e., Step 6 can be executed any time after Step 5.

In order to evaluate the efficiency of the proposed filter structure, it was compared with the Madgwick orientation filter through various simulations. Monte Carlo simulations over a variety of sensor characteristics and reference angular velocities were performed to provide a detailed comparison between the two filters. For each filter under a test case with certain sensor characteristics, a sweep over the filter gain β was performed to find its optimal value, which minimizes the Root Mean Square (RMS) error in calculating the reference Euler angles.

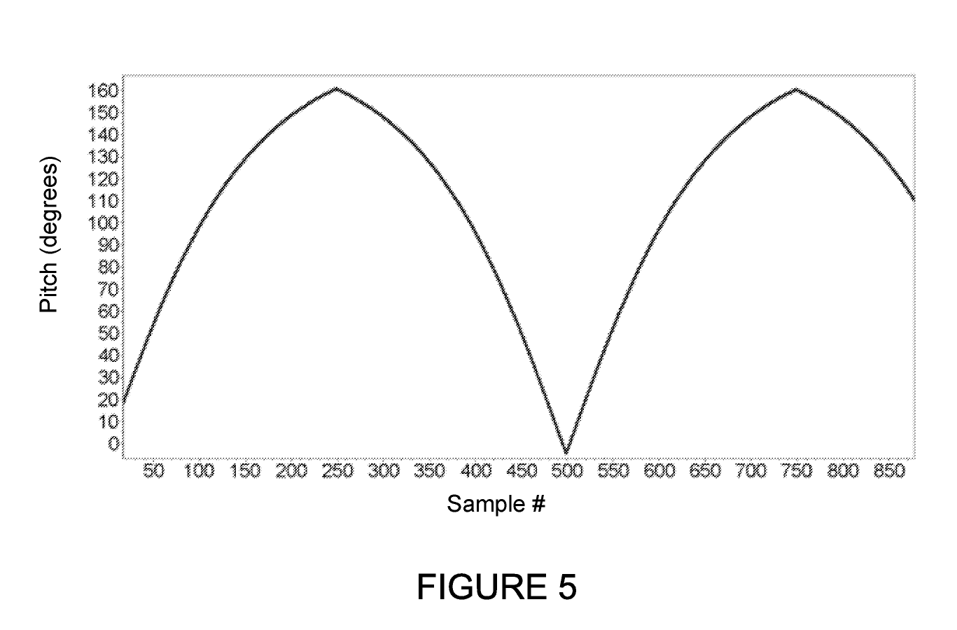

In the first experiment the reference motion was generated as a rotation around the y-axis (Pitch) with variable angular velocities. Using the sampling frequency of 100 Hz, 10,000 samples with different pitch angles were generated. FIG. 5 depicts a subset of the samples, which follow a specific motion pattern. The angular velocity starts high and it slows down until it reaches about 160 degrees in pitch. Next, the rotation direction changes and the absolute angular velocity is increased again until it comes back to 0 degrees in pitch at a fast pace. The rotation changes direction again at this fast pace and starts to slow down again. This pattern was repeated for 10,000 samples.

The reference angular velocities were generated with the following characteristics: average absolute angular velocity in pitch: 71.4°/s; and maximum absolute angular velocity in pitch: 114.6°/s.

For this experiment two scenarios were considered for the sensor errors:

Scenario 1 (Gyros with little noise): Gyro errors (ê_{gx}, ê_{gy}, ê_{gz}) were modeled with a zero-mean Gaussian noise with the standard deviation of 1°/s. Accelerometer errors (êₐₓ, ê_{ay}, ê_{az}) were also modeled with a zero-mean Gaussian noise with the standard deviation of 0.03, which corresponds to a typical error of about 3 degrees.

Scenario 2 (Gyros with more noise): With the same normal distribution models, the gyro errors were modeled with the standard deviation of 2°/s, i.e., gyros with less accuracy.

The results of using Monte Carlo simulations for 10,000 samples considering the reference motion pattern in FIG. 5 are represented in Table I.

TABLE 1

| Estimation | Dynamic RMS error in degrees | |
|---|---|---|
| Method | Scenario 1 | Scenario 2 |
| Gyros only | 0.4373 | 1.2896 |
| Madgwick | 0.2084 (βₒₚₜ = 0.005) | 0.3447 (βₒₚₜ = 0.009) |
| OMID | 0.1587 (βₒₚₜ = 0.144) | 0.218 (βₒₚₜ = 0.279) |
| | 23.8% improvement | 36.7% improvement |

Table 1 compares the results found by a) gyros only (β=0), b) Madgwick's approach, and c) the proposed method, referred to as “OMID” for Orientation Model for Inertial Devices. The value of β is independently optimized for the Madgwick approach and the proposed solution, to reach maximum accuracy by minimizing the dynamic RMS error in calculating the pitch angles.

As shown in Table 1, when gyros tend to deliver lower accuracy (Scenario 2), the IMU filters greatly improve the overall RMS error compared to the case where gyros are used alone for orientation estimation. The improvements offered by the proposed filter are magnified as gyros show lower precision (Scenario 2). It is also notable that the optimal filter gain βₒₚₜ is higher in the proposed solution compared to Madgwick's filter.

In the second experiment the effect of having a higher rate of orientation change on the accuracy of the filters was evaluated. In order to achieve this, a reference motion pattern was generated with 10,000 samples similar to the one in FIG. 5, but with higher angular velocities with the following characteristics: average absolute angular velocity in pitch: 229.4°/s, and maximum absolute angular velocity in pitch: 343.8°/s. The same sampling frequency of 100 Hz was used in this experiment as well. The gyros and accelerometers in this experiment are modeled with the same error as described by Scenario 1 and Scenario 2. The results are summarized in Table 2.

TABLE 2

| Estimation | Dynamic RMS error in degrees | |
|---|---|---|
| Method | Scenario 1 | Scenario 2 |
| Gyros only | 0.6285 | 2.9465 |
| Madgwick | 0.2896 (βₒₚₜ = 0.009) | 0.3979 (βₒₚₜ = 0.012) |
| OMID | 0.1645 (βₒₚₜ = 0.18) | 0.2182 (βₒₚₜ = 0.315) |
| | 43.2% improvement | 45.2% improvement |

As can be seen in Table 2, the improvements found by the proposed solution are magnified compared to the results in Table 1. This is mainly due to the use by Madgwick of the information from the previous sample for the initial guess, i.e., a q_{est,t-1}, which makes it less efficient in tracking faster motions, where the average rate of orientation change is higher. The proposed solution, on the other hand, uses q_{g,t} as the initial guess, and thus, does not fall behind.

In the next experiment, the efficiency of both the proposed filter and Madgwick's solution were evaluated in their ability to track the gyros' zero-bias drift in noisy measurements. The same reference motion pattern as used in the previous experiment with the sensor error models from Scenario 2 were used herewith. The optimal values of β for Scenario 2, which are shown in Table 2, were chosen for the filters. Next, the bias-correction gain ξ was set for both filters separately, such that it satisfied a 45-second step-response time, i.e., the amount of time it takes for the step response to reach 90% of the final steady-state value.

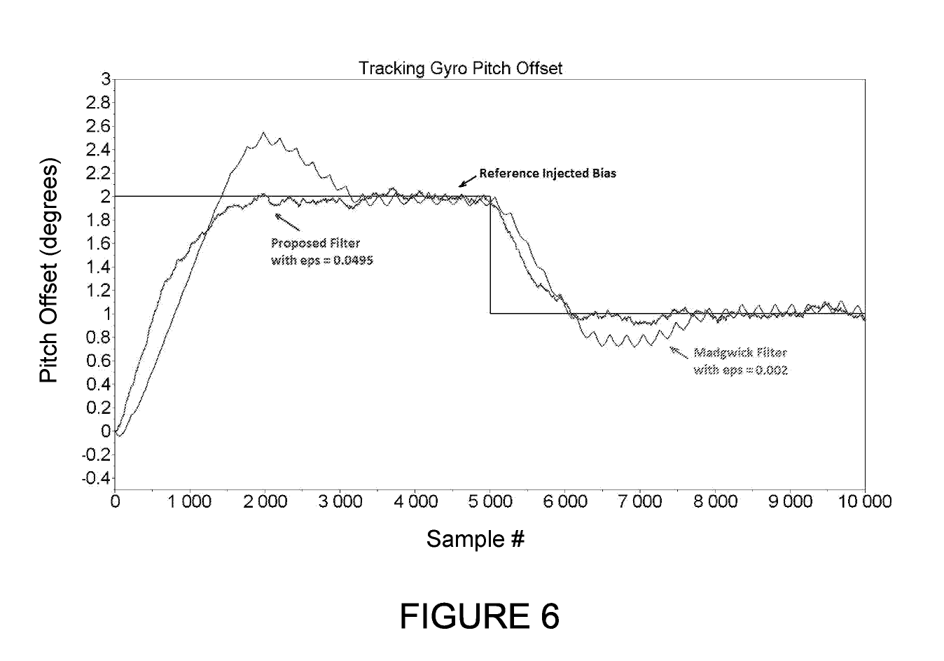

After finding the optimal filter gains β and ξ, a reference time-varying offset was injected to the gyro readings in pitch as shown in FIG. 6. The offset is initially set to 2°/s, which is later reduced to 1°/s. The proposed solution outperforms the Madgwick filter by delivering a smoother response in tracking the gyro drift. The reason the proposed solution is capable of tracking the bias drift more smoothly is that it directly calculates a mismatch representing the difference between the current gyro estimate q_{g,t}, and the current Acc/Mag readings, i.e., ∇F(q_{g,t}, S_{am,t}). In contrast, the Madgwick filter computes a normalized mismatch representing the error between the previous estimate and the current Acc/Mag readings,

$$i . e . , \frac{∇ F ( {q}_{est , t - 1} , {S}_{am , t} )}{‖ ∇ F ‖} .$$

Hence, it Tails to observe the actual desirable mismatch.

Other improvements were also observed in the final Euler angle calculation in the presence of zero-bias drift. Table 3 summarizes the results, indicating a 79.8% improvement in dynamic RMS error in calculating the pitch angles. This improvement is also based on the fact that gyros on their own are less accurate in the presence of zero-bias drift, which makes the proposed filter more accurate compared to Madgwick's, since it allows for the gradient descent algorithm to collect information from gyro readings along with Acc/Mag readings.

TABLE 3

| Estimation | | | Dynamic RMS |
|---|---|---|---|
| Method | βₒₚₜ | ξ | error in degrees |
| Madgwick | 0.012 | 0.002 | 2.0628 |
| OMID | 0.315 | 0.0495 | 0.4171 |

In the final experiment the proposed MARG filter 400 and its Madgwick counterpart were compared. Reference simultaneous angular velocities in pitch and yaw were generated with a pattern similar to that of FIG. 5 and with the following characteristics: average absolute angular velocity in pitch: 214.8°/s; maximum absolute angular velocity in pitch: 343.8°/s; average absolute angular velocity in yaw: 92.1°/s; and maximum absolute angular velocity in yaw: 229.2°/s.

Scenario 2 was considered, i.e., gyro readings with 2°/s standard deviation, and accelerometers with the standard deviation of 0.03. Since MARG sensors were being evaluated, it was assumed that the magnetometer errors (êₘₓ, ê_{my}, ê_{mz}) have a zero-mean Gaussian distribution with the standard deviation of 0.03. The gain value β was optimized separately again for each filter to deliver optimal accuracy. The Monte Carlo simulation results over 10,000 samples are summarized in Table 4.

TABLE 4

| Estimation | Dynamic RMS error in degrees | |
|---|---|---|
| Method | Pitch | Yaw |
| Gyros only | 3.63 | 6.77 |
| Madgwick | 0.6278 | 0.4885 |
| (βₒₚₜ = 0.027) | | |
| OMID | 0.3516 | 0.3948 |
| (βₒₚₜ = 0.486) | 44% improvement | 19.2% improvement |

It is notable that since the yaw angle is following a slower motion compared to the pitch angle (average angular velocity is 57% slower in yaw), the improvement in yaw will not be as high as the improvement obtained in pitch.

In general, there is described herein a computationally efficient quaternion-based orientation estimation method for a moving object using a specialized gradient descent correction step. In some embodiments, the moving object integrates a 3-axis gyroscope capturing angular velocities, a 3-axis accelerometer capturing the gravity vector, a 3-axis magnetometer capturing the earth's magnetic field, as well as a microcontroller to perform the calculations. While the proposed method's applicability has been demonstrated for embedded applications, and particularly low-cost and low-power applications, it may also be used for offline or remote orientation estimations of an object moving in space. Sensor readings may be transmitted remotely to an offline device using various wire-based technologies, such as electrical wires or cables, and/or optical fibers, or wireless technologies, such as RF, infrared, Wi-Fi, Bluetooth, and others.

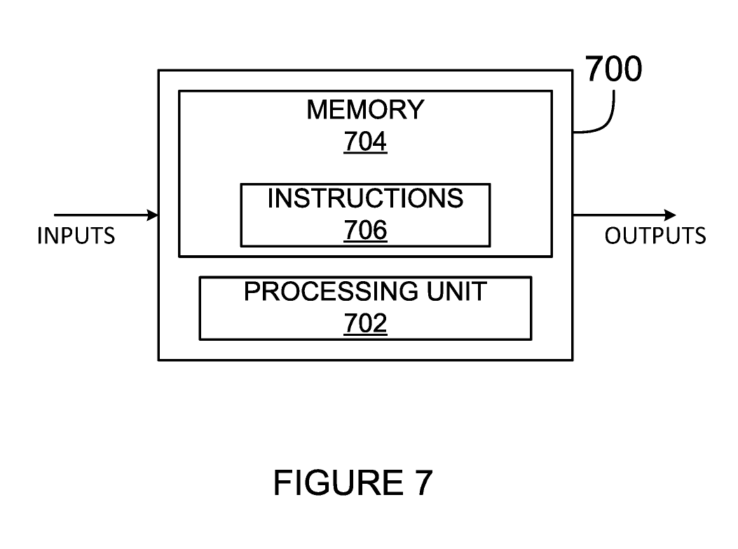

With reference to FIG. 7, the method 100 may be implemented by a computing device 700, comprising a processing unit 702 and a memory 704 which has stored therein computer-executable instructions 706. The processing unit 702 may comprise any suitable devices configured to cause a series of steps to be performed so as to implement the method 100 such that instructions 706, when executed by the computing device 700 or other programmable apparatus, may cause the functions/acts/steps specified in the methods described herein to be executed. The processing unit 702 may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof. The arithmetic operations involved in the method of estimating the orientation can be executed on the processing unit 702 using finite precision number formats including but not limited to fixed-point or floating-point arithmetic.

The memory 704 may comprise any suitable known or other machine-readable storage medium. The memory 704 may comprise non-transitory computer readable storage medium such as, for example, but not limited to, an electronic, magnetic, optical, electromagnetic, infrared, or semiconductor system, apparatus, or device, or any suitable combination of the foregoing. The memory 704 may include a suitable combination of any type of computer memory that is located either internally or externally to the computing device 700, such as random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may be a program memory in the form of ferroelectric RAM, NOR flash, or OTP ROM provided on a chip. Memory 704 may comprise any storage means (e.g., devices) suitable for retrievably storing machine-readable instructions executable by processing unit 702.

The methods and systems for estimating an orientation of a moving object in three-dimensional space described herein may be implemented in a high level procedural or object oriented programming or scripting language, or a combination thereof, to communicate with or assist in the operation of a computer system, for example the computing device 700. Alternatively, the methods and systems for estimating an orientation of a moving object in three-dimensional space described herein may be implemented in assembly or machine language. The language may be a compiled or interpreted language. Embodiments of the methods and systems for estimating an orientation of a moving object in three-dimensional space described herein may also be considered to be implemented by way of a non-transitory computer-readable storage medium having a computer program stored thereon. The computer program may comprise computer-readable instructions which cause a computer, or more specifically at least one processing unit of the computer, to operate in a specific and predefined manner to perform the functions described herein.

Computer-executable instructions may be in many forms, including program modules, executed by one or more computers or other devices. Generally, program modules include routines, programs, objects, components, data structures, etc., that perform particular tasks or implement particular abstract data types. Typically the functionality of the program modules may be combined or distributed as desired in various embodiments.

The above description is meant to be exemplary only, and one skilled in the relevant arts will recognize that changes may be made to the embodiments described without departing from the scope of the invention disclosed. For example, the blocks and/or operations in the flowcharts and drawings described herein are for purposes of example only. There may be many variations to these blocks and/or operations without departing from the teachings of the present disclosure. For instance, the blocks may be performed in a differing order, or blocks may be added, deleted, or modified. While illustrated in the block diagrams as groups of discrete components communicating with each other via distinct data signal connections, it will be understood by those skilled in the art that the present embodiments are provided by a combination of hardware and software components, with some components being implemented by a given function or operation of a hardware or software system, and many of the data paths illustrated being implemented by data communication within a computer application or operating system. The structure illustrated is thus provided for efficiency of teaching the present embodiment.

The present disclosure may be embodied in other specific forms without departing from the subject matter of the claims. Also, one skilled in the relevant arts will appreciate that while the systems, methods and computer readable mediums disclosed and shown herein may comprise a specific number of elements/components, the systems, methods and computer readable mediums may be modified to include additional or fewer of such elements/components. The present disclosure is also intended to cover and embrace all suitable changes in technology. Modifications which fall within the scope of the present invention will be apparent to those skilled in the art, in light of a review of this disclosure, and such modifications are intended to fall within the appended claims.

1. A computer-implemented method for estimating an orientation of a moving object in three-dimensional space, the method comprising:
obtaining filtered and calibrated angular velocity readings of the object;
computing a first correction vector by directing a quaternion orientation estimate at time t−1 towards the angular velocity readings found at time t to generate a quaternion orientation estimate of the angular velocity readings at time t;
obtaining filtered and calibrated proper acceleration readings of the object;
computing a second correction vector by directing the quaternion orientation estimate of the angular velocity readings at time t towards the proper acceleration readings found at time t; and
using the second correction vector as a measurement error for estimating the orientation of the moving object at time t.

2. The method of claim 1, further comprising obtaining filtered and calibrated heading angle readings of the object, and wherein computing the second correction vector comprises directing the quaternion orientation estimate of the angular velocity readings at time t towards the proper acceleration readings and the heading angle readings found at time t.

3. The method of claim 1, further comprising detecting a temporary disturbance in the proper acceleration readings at time t, and adjusting the second correction vector at time t to account for the temporary disturbance.

4. The method of claim 3, wherein adjusting the second correction vector at time t comprises applying at least one confidence weight to the proper acceleration readings, and adjusting the confidence weight at time t when the temporary disturbance is detected.

5. The method of claim 2, further comprising detecting a temporary disturbance in at least one of the proper acceleration readings and the heading angle readings at time t, and adjusting the second correction vector at time t to account for the temporary disturbance.

6. The method of claim 1, further comprising determining a zero-bias drift in the angular velocity readings for stationary positions of the object by computing a mean value of the angular velocity readings, and correcting for the zero-bias drift.

7. The method of claim 2, further comprising determining a zero-bias drift in the angular velocity readings for stationary or non-stationary positions of the object using the quaternion orientation estimate at time t−1, and correcting for the zero-bias drift.

8. The method of claim 1, wherein the first correction vector and the second correction vector are both quaternions, computing the first correction vector comprises numerically integrating a quaternion derivative which is found using the proper angular velocity readings, and computing the second quaternion comprises computing a gradient descent.

9. The method of claim 1, wherein the method is implemented by an inertial measurement unit (IMU) sensor array.

10. The method of claim 2, wherein the method is implemented by a Magnetic Angular Rate and Gravity (MARG) sensor array.

11. A system for estimating an orientation of a moving object in three-dimensional space, the system comprising:
a processing unit; and
a non-transitory memory communicatively coupled to the processing unit and comprising computer-readable program instructions executable by the processing unit for:
obtaining filtered and calibrated angular velocity readings of the object;
computing a first correction vector by directing a quaternion orientation estimate at time t−1 towards the angular velocity readings found at time t to generate a quaternion orientation estimate of the angular velocity readings at time t;
obtaining filtered and calibrated proper acceleration readings of the object;
computing a second correction vector by directing the quaternion orientation estimate of the angular velocity readings at time t towards the proper acceleration readings found at time t; and
using the second correction vector as a measurement error for estimating the orientation of the moving object at time t.

12. The system of claim 11, wherein the memory and processing unit are provided on a single integrated circuit as part of a microcontroller.

13. The system of claim 11, wherein the system is embedded on the object.

14. The system of claim 11, wherein the program instructions are further executable by the processing unit for obtaining filtered and calibrated heading angle readings of the object, and wherein computing the second correction vector comprises directing the quaternion orientation estimate of the angular velocity readings at time t towards the proper acceleration readings and the heading angle readings found at time t.

15. The system of claim 11, wherein the program instructions are further executable by the processing unit for detecting a temporary disturbance in the proper acceleration readings at time t, and adjusting the second correction vector at time t to account for the temporary disturbance.

16. The system of claim 15, wherein adjusting the second correction vector at time t comprises applying at least one confidence weight to the proper acceleration readings, and adjusting the confidence weight at time t when the temporary disturbance is detected.

17. The system of claim 14, wherein the program instructions are further executable by the processing unit for detecting a temporary disturbance in at least one of the proper acceleration readings and the heading angle readings at time t, and adjusting the second correction vector at time t to account for the temporary disturbance.

18. The system of claim 11, wherein the program instructions are further executable by the processing unit for determining a zero-bias drift in the angular velocity readings for stationary positions of the object by computing a mean value of the angular velocity readings, and correcting for the zero-bias drift.

19. The system of claim 14, wherein the program instructions are further executable by the processing unit for determining a zero-bias drift in the angular velocity readings for stationary or non-stationary positions of the object using the quaternion orientation estimate at time t−1, and correcting for the zero-bias drift.

20. The system of claim 11, wherein the first correction vector and the second correction vector are both quaternions, computing the first correction vector comprises numerically integrating a quaternion derivative which is found using the proper angular velocity readings, and computing the second quaternion comprises computing a gradient descent.
